(19) United States
(12) Patent Application Publication
(10) Pub. No.: US 2025/0019507 A1
(43) Pub. Date: Jan. 16, 2025

(54) POLYMER FILM

(71) Applicant: CHI-KUNG WU, TAICHUNG CITY (TW)

(72) Inventors: CHI-KUNG WU, TAICHUNG CITY (TW); KUN-CONG LIN, Shenzhen (CN)

(21) Appl. No.: 18/664,579

(22) Filed: May 15, 2024

(30) Foreign Application Priority Data
Jul. 10, 2023 (TW) 112125667

(51) Int. Cl. C08J 5/18

(52) U.S. Cl. CPC C08J 5/18; C08J 2375/04

(57) ABSTRACT

A polymer film is provided, wherein the polymer film is composed of polyol, isocyanate and chain extender. The content ratio in weight of the polyol, the isocyanate and the chain extender is (80.00 to 100.00):(70.00 to 90.00):(10.00 to 20.00). The average functionality of the polyol is greater than or equal to 2, and the average functionality of the chain extender is greater than 2. As such, it has better structural strength and good shock-absorbing and buffering capabilities in various dimensions.

### BACKGROUND OF THE INVENTION

### Field of the Invention

The present invention relates to a polymer film.

### Description of the Prior Art

In daily life, there are many items or applications in many fields, such as clothing (cloths, pants, shoe uppers, elastic belts), pads, shells, covers, etc., all of which have stretching deformation rates, rebound abilities, shock-absorbing effects and other properties, to provide functions such as buffering, auxiliary support, and injury prevention.

Generally, materials such as plastic or rubber are commonly used to produce the above-mentioned clothing pads, shells, covers and other items. Taking the widely used thermoplastic polyurethane (TPU) as an example, its rebound ability is greater than 20% such that its shock-absorbing and buffering effect is poor. In addition, the force required to stretch the material at low speed is large, and the greater the deformation of the material, the required stretching force increases sharply. If this conventional material is applied to wearable objects, it cannot provide appropriate tensile properties when the wearer is stationary or in motion, effective support, effective shock absorption and other properties, which has poor ergonomic performance and poor wearing comfort.

The present invention is, therefore, arisen to obviate or at least mitigate the above-mentioned disadvantages.

### SUMMARY OF THE INVENTION

The main object of the present invention is to provide a polymer film which has better structural strength, excellent tensile properties and good shock-absorbing and buffering capabilities in various dimensions

To achieve the above and other objects, a polymer film is provided, wherein the polymer film is composed of polyol, isocyanate and chain extender. The content ratio in weight of the polyol, the isocyanate and the chain extender is (80.00 to 100.00):(70.00 to 90.00):(10.00 to 20.00). The average functionality of the polyol is greater than or equal to 2, and the average functionality of the chain extender is greater than 2. As such, it has better structural strength and good shock-absorbing and buffering capabilities in various dimensions.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a schematic diagram of an exemplary embodiment of the present invention;

FIG. 2 is a schematic diagram of a polymer film in a tensile state according to an exemplary embodiment of the present invention;

FIG. 3 is a partial enlarged view of FIG. 1;

FIG. 4 is a partial enlarged view of FIG. 2; and

FIG. 5 is a chart of stretching test on the polymer film of an exemplary embodiment of the present invention.

### DETAILED DESCRIPTION OF THE PREFERRED EMBODIMENTS

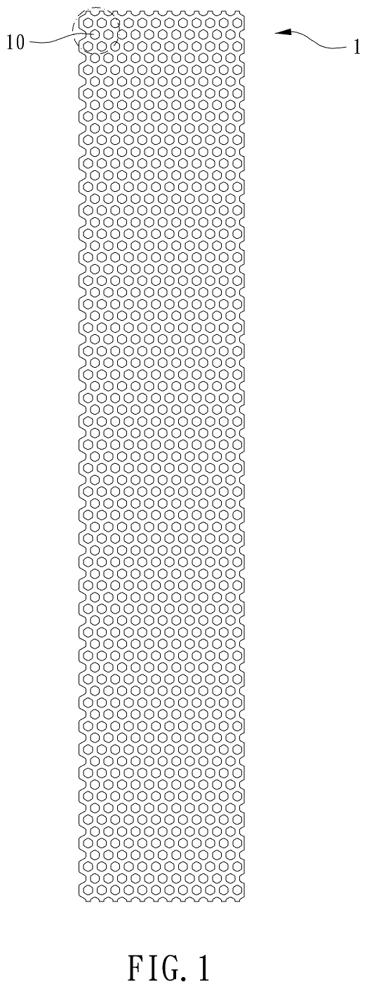

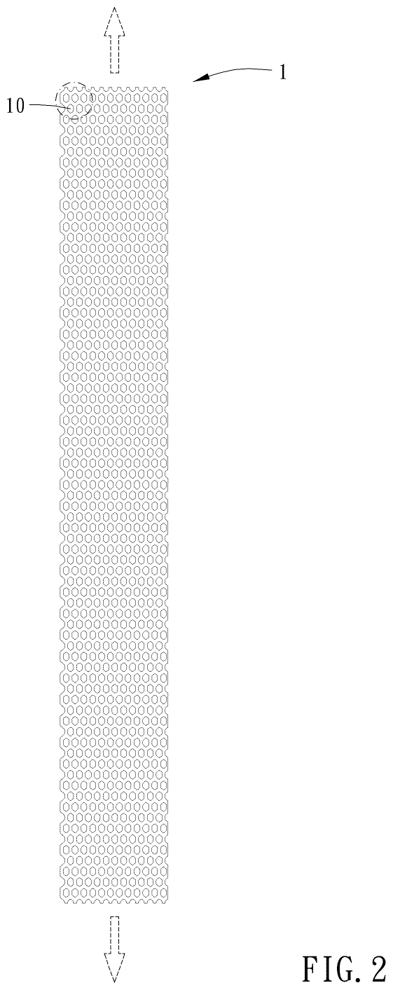

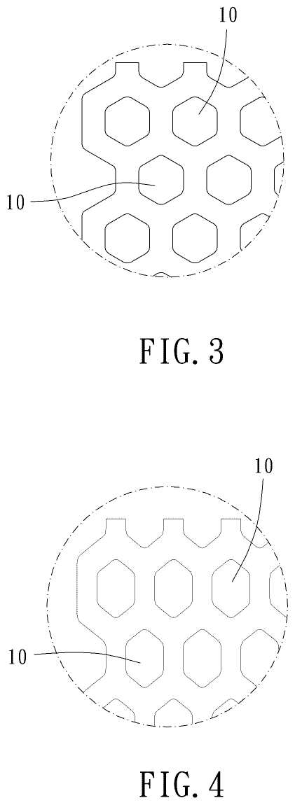

Please refer to FIGS. 1 to 4 for an exemplary embodiment of the present invention. A polymer film 1 of the present invention is composed of polyol, isocyanate and chain extender. The content ratio in weight of the polyol, the isocyanate and the chain extender is (80.00 to 100.00):(70.00 to 90.00):(10.00 to 20.00). The average functionality of the polyol is greater than or equal to 2, and the average functionality of the chain extender is greater than 2. The average functionality of the isocyanate may be greater than 2. Molecules with functionality of 1 can only form dimers, monomers with a functionality of 2 can form linear polymers, and molecules with functionality greater than 2 can form three-dimensional polymers. A stereopolymer is stronger than a linear polymer. The average functionality of the polyol is greater than or equal to 2 and the average functionality of the chain extender is greater than 2 so that it forms a stereopolymer which has better structural strength and good shock-absorbing and buffering capabilities in various dimensions.

The polyol is polyether polyol or polyester polyol, the chain extender is 1.4 1.4-butanediol, 1.6-hexanediol, diethylene glycol, dipropylene glycol, 1,2,3,-propanetriol or trimethylolpropane, and wherein the polyol and the chain extender are different from each other. The polyol has a molecular weight of 300 to 2000, the isocyanate has a molecular weight of 320 to 400, and the chain extender has a molecular weight of 90 to 400. Preferably, the molecular weight of the polyol is 500 to 1200, the molecular weight of the isocyanate is 350 to 370, and the molecular weight of the chain extender is 200 to 300. The content ratio in weight of the polyol, the isocyanate and the chain extender is (85.00 to 95.00):(75.00 to 85.00):(13.00 to 17.00). Preferably, the content ratio in weight of the polyol, the isocyanate and the chain extender is 90.00:79.00:15.00.

The rebound ability of the polymer film is less than or equal to 20%, the rebound ability is defined as the percentage of a rebound height compared to a drop height, the drop height is defined as a height of an object relative to the polymer film, and the rebound height is defined as a maximum height of the object relative to the polymer film to which the object is rebounded by the polymer film to reach. Preferably, the rebound ability is 12% to 14%. Compared with a conventional polymer film (such as TPU film) whose rebound ability is greater than 20%, the polymer film 1 of the present invention obviously has better shock-absorbing and buffering effects.

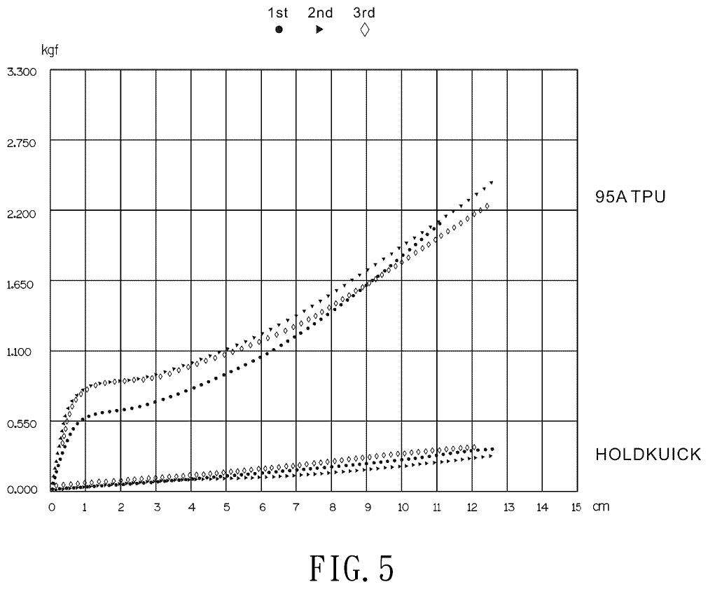

FIG. 5 shows the tensile test results of the polymer film 1 and the conventional code-named 95A TPU film at low speed. The test was conducted at a stretching speed of 25 millimeters (mm) per minute. It clearly shows that the force required to pull the conventional code-named 95A TPU film at low speed is relatively large, that the larger the deformation, the greater the pulling force required, and that when the tensile deformation is 12 centimeters (cm), the pulling force sharply increases to about 2.200 kilogram weight (kgf); however, it requires relatively very small force to pull the polymer film 1 of the present invention (named as HOLDKUICK in FIG. 5) at low speed, and when the tensile deformation is 12 cm, the pulling force is only about 0.400 kgf which is only 0.182 times that of the conventional code-named 95A TPU film, which is suitable for wearable items that require mobility and comfort.

In this embodiment, the polymer film 1 further includes a plurality of through holes 10, the plurality of through holes 10 are polygonal or circular and evenly distributed thereon, which saves materials, is lightweight, reduces costs, and can provide good physical permeability (such as air permeability, liquid permeability, etc.). The plurality of through holes 10 are, for example, hexagonal, round or of other shapes, and the plurality of through holes 10 may be through holes or blind holes. However, the polymer film 1 may not have any through holes, which provides a comprehensive shock-absorbing and buffering effect.

In this embodiment, the polymer film 1 is an elastic member whose shear stress is in nonlinear proportion to shear strain. Under tests of different stretching speeds, for example, with the clamping points of an interval of 20 mm and with the stretching speed of 100 mm per minute, the yield point stress of the conventional code-named 95A TPU film is 63.248 kgf per square centimeter; with a stretching speed of 3000 millimeters per minute, the yield point stress of the conventional code-named 95A TPU film is 67.678 kgf per square centimeter; and it shows that the difference in yield point stress under the two conditions is very small, which means when subjected to different degrees of external forces, there is a little difference in energy absorption ability and rebound effect, and the shock absorption and buffering effect is poor. As to the polymer film 1 of the present invention, with the clamping points of an interval of 20 mm and with the stretching speed of 100 mm per minute, the yield point stress of the polymer film 1 is 13.984 kgf per square centimeter; with a stretching speed of 3000 millimeters per minute, the yield point stress of the polymer film 1 is 33.205 kgf per square centimeter; and it shows that the difference in yield point stress under the two conditions is larger than 2 times the yield point stress of the polymer film 1 at the stretching speed of 100 mm per minute, which means when subjected to different degrees of external forces, there is a large difference in energy absorption ability and rebound effect, and the shock absorption and buffering effect is good, so that it can absorb a large amount of energy quickly and reduce the rebound, further improving the shock-absorbing and buffering effect when subjected to external impact.

The polymer film 1 can be combined with or applied to clothing (clothes, pants, shoe uppers, elastic belts or the like), pads, shells, covers and other articles in various fields. For example, the polymer film 1 is combined with fabrics or cloths to provide appropriate tensile characteristics, effective support, effective shock absorption and other properties according to the stretching deformation rate, rebound speed, shock-absorbing buffering effect and other requirements of different areas. As such, whether the wearer is stationary or in motion, the polymer film 1 has excellent performance, is ergonomic, and significantly improves wearing comfort.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A polymer film being composed of polyol, isocyanate and chain extender, the content ratio in weight of the polyol, the isocyanate and the chain extender being (80.00 to 100.00):(70.00 to 90.00):(10.00 to 20.00), the average functionality of the polyol being greater than or equal to 2, the average functionality of the chain extender being greater than 2.

2. The polymer film of claim 1, wherein the polyol has a molecular weight of 300 to 2000, the isocyanate has a molecular weight of 320 to 400, and the chain extender has a molecular weight of 90 to 400.

3. The polymer film of claim 2, wherein the molecular weight of the polyol is 500 to 1200, the molecular weight of the isocyanate is 350 to 370, and the molecular weight of the chain extender is 200 to 300.

4. The polymer film of claim 1, wherein the content ratio in weight of the polyol, the isocyanate and the chain extender is (85.00 to 95.00):(75.00 to 85.00):(13.00 to 17.00).

5. The polymer film of claim 4, wherein the content ratio in weight of the polyol, the isocyanate and the chain extender is 90.00:79.00:15.00.

6. The polymer film of claim 1, wherein the rebound ability of the polymer film is less than or equal to 20%, the rebound ability is defined as the percentage of a rebound height compared to a drop height, the drop height is defined as a height of an object relative to the polymer film, and the rebound height is defined as a maximum height of the object relative to the polymer film to which the object is rebounded by the polymer film to reach.

7. The polymer film of claim 6, wherein the rebound ability is 12% to 14%.

8. The polymer film of claim 1, wherein the polyol is polyether polyol or polyester polyol, the chain extender is 1.4 1.4-butanediol, 1.6-hexanediol, diethylene glycol, dipropylene glycol, 1,2,3,-propanetriol or trimethylolpropane, and wherein the polyol and the chain extender are different from each other.

9. The polymer film of claim 3, wherein the content ratio in weight of the polyol, the isocyanate and the chain extender is (85.00 to 95.00):(75.00 to 85.00):(13.00 to 17.00); the rebound ability of the polymer film is less than or equal to 20%, the rebound ability is defined as the percentage of a rebound height compared to a drop height, the drop height is defined as a height of an object relative to the polymer film, and the rebound height is defined as a maximum height of the object relative to the polymer film to which the object is rebounded by the polymer film to reach; the rebound ability is 12% to 14%; the polymer film further includes a plurality of through holes, the plurality of through holes are polygonal or circular and evenly distributed thereon; the polyol is polyether polyol or polyester polyol, the chain extender is 1.4 1.4-butanediol, 1.6-hexanediol, diethylene glycol, dipropylene glycol, 1,2,3,-propanetriol or trimethylolpropane, and wherein the polyol and the chain extender are different from each other.

10. The polymer film of claim 1, wherein the polymer film is an elastic member whose shear stress is in nonlinear proportion to shear strain.
